(19) United States
(12) Patent Application Publication
(10) Pub. No.: US 2025/0323490 A1
(43) Pub. Date: Oct. 16, 2025

(54) ELECTRICAL PROTECTION DEVICE, ELECTRICAL INSTALLATION AND ASSOCIATED CONTROL METHOD

(71) Applicant: Schneider Electric Industries SAS, Rueil-Malmaison (FR)

(72) Inventors: Sébastien Heraud, Grenoble (FR); Rémy Orban, Saint Martin d'Uriage (FR); Lucas Salvetti, Eybens (FR); Vincent Chauve, Colombe (FR)

(73) Assignee: Schneider Electric Industries SAS, Rueil-Malmaison (FR)

(21) Appl. No.: 19/171,648

(22) Filed: Apr. 7, 2025

(30) Foreign Application Priority Data
Apr. 10, 2024 (FR) 2403695

(51) Int. Cl. H02H 3/08; H02H 1/00; H02H 9/04

(52) U.S. Cl. CPC H02H 3/08; H02H 1/0007; H02H 9/04

(57) ABSTRACT

The present invention relates to an electrical protection device comprising:
a mechanical switch;
an interruption cell (18) comprising N switching modules (32, 42), N being greater than or equal to 2, each switching module (32, 42) comprising a voltage-limiting element (39, 49),
each voltage-limiting element having a different limiting voltage (Uₗᵢₘ₁, Uₗᵢₘ₂);
a control unit comprising a cell control module (66), configured to control each switching module to enter the off-configuration,
the limiting voltages, alone and/or summed together, form at least 2^{N}−1 distinct levels, and the cell control module is configured to control the switching module(s) whose limiting voltages form a level that is the highest level less than or equal to a dielectric strength of the mechanical switch, to enter the off-configuration.

### FIELD

The present invention relates to an electrical protection device, an electrical installation and an associated control method.

### BACKGROUND

It is known to use electrical protection devices comprising a mechanical switch, and an interruption cell comprising at least one switching module comprising a semiconductor element connected in parallel with a voltage-limiting element. These protection devices are also known as hybrid circuit breakers. US2022122801A1 describes a hybrid circuit breaker for high-voltage direct current, comprising a main circuit breaker with a number of switching modules connected in series. When a short-circuit fault is detected and the electrical current needs to be interrupted, the switching modules are opened successively, reducing the time taken to interrupt the short-circuit fault and limiting the peak current in the installation.

However, this known hybrid circuit breaker comprises an auxiliary switch, connected in series with the mechanical switch, an assembly comprising the auxiliary switch and the mechanical switch being connected in parallel with the main circuit breaker. The auxiliary switch generates significant electrical losses, for example losses caused by thermal dissipation, and increases the number of components required to build the hybrid circuit breaker. In addition, opening the switching modules one after another does not reduce the interruption time of the short-circuit fault or limit the peak current optimally.

### SUMMARY

The aim of the invention is therefore to offer a protection device that reduces electrical losses and limits the number of components, while reducing the interruption time of the short-circuit fault and limiting the peak current.
To this end, the subject of the invention is an electrical protection device, configured to be connected between a source and a load, the device comprising:
   a mechanical switch, configured to switch between a closed configuration, wherein the mechanical switch conducts a current flowing between the source and the load, and an open configuration, wherein the mechanical switch does not conduct the current;
   an interruption cell, connected in parallel with the mechanical switch, the interruption cell comprising N switching modules connected in series with each other, N being greater than or equal to 2, each switching module comprising:
      at least one semiconductor element;
      a voltage-limiting element connected in parallel with the semiconductor element(s),
each voltage-limiting element having a limiting voltage, different from the limiting voltage of the other voltage-limiting elements, each switching module being configured to switch between an on-configuration, wherein the current flows through the or one of the semiconductor elements of the switching module, and an off-configuration, wherein if the current flows through the switching module, it flows through the voltage-limiting element;
   a current sensor, configured to measure a current intensity;
   a control unit comprising:
      a detection module configured to detect an electrical fault of the short-circuit type as a function of the intensity measured by the current sensor;
      a mechanical switch control module, configured to control the mechanical switch to enter the open configuration when an electrical fault is detected,
      a cell control module, configured to control each switching module in the off-configuration,
According to the invention, an input of the mechanical switch and an input of the interruption cell are connected to each other by a non-interruptible electrical link and an output of the mechanical switch and an output of the interruption cell are connected to each other by a non-interruptible electrical link,
the limiting voltages, alone and/or summed together, form at least 2^{N}−1 distinct levels,
and the cell control module is configured to:
   control the switching module(s) whose limiting voltages of the voltage-limiting elements form a given level to enter the off-configuration, the given level being the highest level less than or equal to a dielectric strength of the mechanical switch, and
   control the other switching modules to enter the on-configuration.

The fact that the electrical connection is non-interruptible means that the device does not comprise an auxiliary switch. Thanks to the invention, the number of components in the electrical device is reduced and electrical and thermal losses are minimised, thereby improving the performance of the device.

In addition, thanks to the invention, the switching modules are no longer controlled successively, but in such a way that the limiting voltages of the various switching modules are combined to form a maximum number of levels, in this case 2^{N}−1 levels, and not N levels. This way, the current is more finely limited, provided that the dielectric strength of the mechanical switch is greater than or equal to one of the levels. This makes it possible, without increasing the number of switching modules compared with the case where the switching modules are controlled successively, to limit an increase in the current caused by the electrical fault of the short-circuit type as early as possible, and therefore to limit the stresses in the loads or even in the cables connecting the device, source and load while guaranteeing a leakage current from the voltage-limiting elements that is compatible with the energy resistance of the device components.

In other beneficial aspects of the invention, the device comprises one or more of the following features, taken in isolation or in any technically possible combination:
Each switching module comprises two semiconductor elements that conduct current in only one direction and are connected in series with opposite orientations, and for each semiconductor element, a diode is connected in parallel with opposite orientations to the semiconductor element.
   The interruption cell comprises two rectifying branches, the input and output of the interruption cell respectively forming a midpoint of one of the rectifying branches, each rectifying branch comprising two diodes arranged on either side of the midpoint, connected to one another in series with opposite orientations;
      the switching modules are connected in parallel with the rectifying branches; and
      each switching module comprises a single semiconductor element connected in parallel with the voltage-limiting element.
   The device comprises at least three switching modules.
   One of the switching modules, referred to as a variable-voltage switching module, comprises a plurality of voltage-limiting elements each having a different limiting voltage from one another and different from the limiting voltages of the voltage-limiting elements of the other switching modules;
      each voltage-limiting element of the variable-voltage switching module is associated with a switching member with which it is connected in series, each voltage-limiting element and its associated switching member being connected in parallel with the semiconductor element(s);
      the levels are formed by at most one limiting voltage of a voltage-limiting element of the variable-voltage switching module, possibly summed with one or more limiting voltages of the other switching modules; and
      the cell control module is further configured to, when a given limiting voltage element of the variable voltage switching module forms part of a given level, the given level being the highest level less than or equal to the dielectric strength of the mechanical switch, toggle the switching member associated with the given limiting voltage element from an on-state to an off-state, and to control the other switching members of the variable-voltage switching module to enter the off-state.
   The device further comprises a disconnector, connected in series with the mechanical switch without being connected in parallel with the interruption cell.
   A tripping time between detection of the electrical fault of the short-circuit type by the detection module and all the switching modules switching to the off-configuration is less than 1 ms, preferably less than 800 μs, even more preferably less than 400 μs.

The invention further relates to an electrical installation comprising a source, a load connected to the source, and an electrical protection device as previously described, connected between the source and the load, a nominal voltage of the current flowing between the source and the load being less than 1500 V.
The invention further relates to a method for controlling an electrical protection device, the method comprising at least the following steps:
   measuring the intensity of the current, by the current sensor;
   detecting an electrical fault of the short-circuit type, by the detection module, as a function of the intensity measured by the current sensor;
   when an electrical fault of the short-circuit type is detected, controlling the mechanical switch to enter the open configuration by means of the mechanical switch control module; and
   when the dielectric strength of the mechanical switch is greater than or equal to a given level, the given level being the highest level less than or equal to the dielectric strength of the mechanical switch, controlling the switching module(s) whose limiting voltages of the limiting elements form the given level, and the other switching modules, to enter the on-configuration.

Advantageously, the method further comprises, when a given limiting voltage element of the variable-voltage switching module forms part of a given level and the dielectric strength of the mechanical switch is greater than or equal to the given level, a step of controlling the switching component associated with the given voltage-limiting element to enter the on-state, and the other switching components of the variable-voltage switching module to enter the off-state.

### BRIEF DESCRIPTION OF THE DRAWINGS

The invention will appear more clearly when reading the description that follows, given solely as a non-limiting example and made in reference to drawings in which:

FIG. 1 is a diagram of an electrical installation comprising an electrical protection device in accordance with a first embodiment of the invention;

FIG. 2 is a diagram of an interruption cell of the electrical protection device according to the first embodiment of the invention;

FIG. 3 is a graphical representation of a voltage and intensity of a current flowing in a protection device in accordance with the invention as a function of time;

FIG. 4 is a flowchart of a control method according to the invention.

FIG. 5 is a diagram of an interruption cell of the electrical protection device according to a second embodiment of the invention; and

FIG. 6 is a diagram of an interruption cell of the electrical protection device according to a third embodiment of the invention.

### DETAILED DESCRIPTION

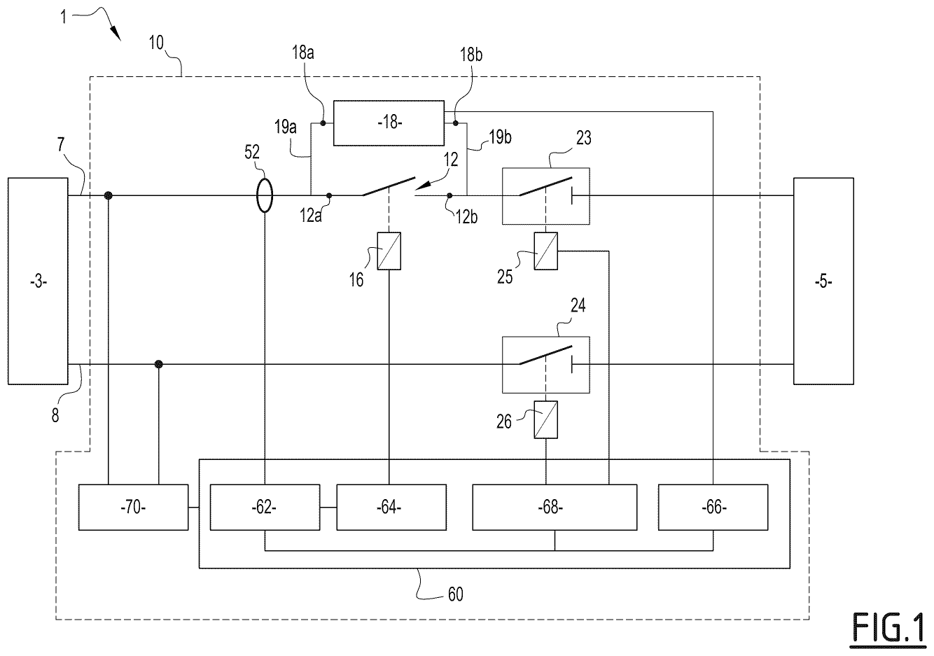

FIG. 1 is a diagram of an electrical installation 1 comprising a source 3 and a load 5, electrically interconnected by a phase conductor 7 and a neutral conductor 8. The source 3 supplies electricity and is, for example, an electrical generator or an electrical network, for example a mains electrical network. The load 5 is a device that consumes electricity, such as a domestic electrical appliance, industrial equipment such as an electric motor, or a server. In this way, an electric current, referred to hereafter simply as current, flows between the source 3 and the load 5 through the phase conductor 7, and returns to the source 3 through the neutral conductor 8.

The current is a low-voltage current, i.e. the nominal voltage Uₛ of the current, also known as the mains voltage, is less than 1500 V. The current is an alternating current or, alternatively, a direct current.

The electrical installation 1 further comprises an electrical protection device 10, hereinafter also referred to as the device, connected between the source 3 and the load 5. The device 10 is configured to switch between an armed configuration, wherein the device 10 conducts the current flowing between the source 3 and the load 5, and a tripped configuration, wherein the device 10 electrically isolates the source 3 from the load 5.

The device 10 comprises a mechanical switch 12, also known as a bypass switch, or fast mechanical switch (FMS). The mechanical switch 12 is connected in series with the phase conductor 7, via an input 12a and an output 12b, and is configured to switch between a closed configuration, wherein it conducts the current flowing between the source 3 and the load 5, and an open configuration, wherein it does not conduct the current. In FIG. 1, the mechanical switch 12 is shown in the open configuration. Advantageously, the device 10 comprises an actuator 16 which, when activated, switches the mechanical switch 12 to the open configuration.

The device 10 comprises an interruption cell 18, connected in parallel with the mechanical switch 12, such that the input 12a and output 12b of the mechanical switch 12 are connected respectively to an input 18a and an output 18b of the interruption cell 18. More specifically, the input 12a of the mechanical switch 12 and the input 18a of the interruption cell 18 are connected by the electrical link 19a, which is non-interruptible, and the output 12b of the mechanical switch 12 is connected to the output 18b of the interruption cell 18 by an electrical link 19b, which is also non-interruptible. In other words, the electrical links 19a and 19b are each an electrical cable or wire; none of the electrical links 19a and 19b comprise a switch or, more generally, a means of interrupting the electrical current. The interruption cell 18 is configured to allow or interrupt the current flowing through it, as explained later.

The device 10 advantageously comprises a first disconnector 23 and, optionally, a second disconnector 24, connected respectively to the phase conductor 7 and the neutral conductor 8. In particular, the disconnector 23 is connected to the phase conductor 7 in series with the mechanical switch 12, without being connected in parallel with the interruption cell 18. Furthermore, the disconnector 23 is connected in series with the neutral conductor 8. The disconnectors 23 and 24 are configured to switch between a closed configuration, wherein the disconnectors 23 and 24 conduct current, and an open configuration, wherein the disconnectors 23 and 24 do not conduct current. Advantageously, and as shown in FIG. 1, the device 10 comprises an actuator 25 of the first disconnector 23 and an actuator 26 of the second disconnector 24 which, when activated, interact respectively with the first disconnector 23 and the second disconnector 24 to cause them to switch to the open configuration. The actuators 25 and 26 are, for example, coils and are activated when a current flows through the turns of the coils.

The disconnectors 23 and 24 are configured to switch to the open position in particular when no current is flowing between the source 3 and the load 5; in other words, when the current has been interrupted by the mechanical switch 12 and/or by the interruption cell 18.

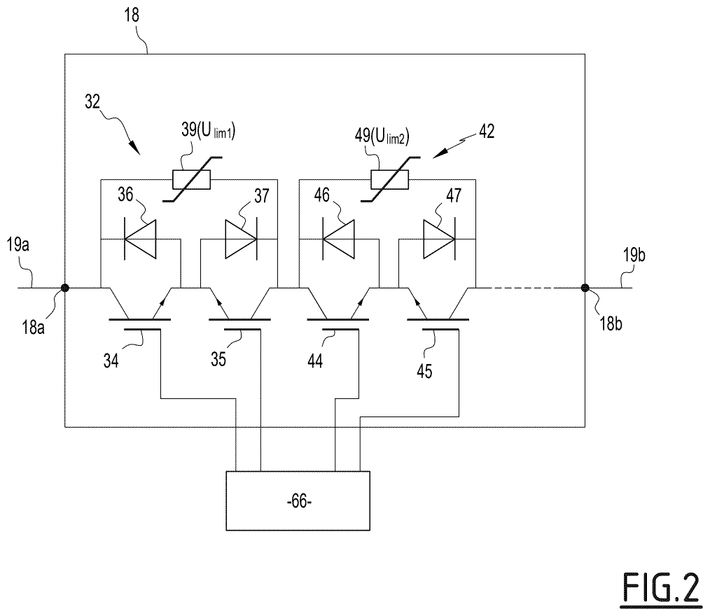

The interruption cell 18 comprises N switching modules, for example N=2 switching modules 32 and 42, as shown in FIG. 2. Alternatively, there are three or more switching modules, as symbolised by the dotted line in FIG. 2.

The switching modules 32 and 42 are connected in series to one another. Each switching module 32 and 42 comprises at least one semiconductor element controllable in switching, for example at least one thyristor or at least one transistor, such as a field effect transistor, also known as a FET (Field Effect Transistor), an insulated gate field effect transistor, also known as a MOSFET (Metal Oxide Semiconductor Field Effect Transistor) transistor, an insulated gate bipolar transistor, or IGBT, or a combination of these different semiconductor elements.

In the example shown in FIG. 2, each switching module 32 comprises two unidirectional current transistors 34 and 35, for example two IGBTs. The conduction direction of transistors 34 and 35 is indicated by an arrow on each transistor 34, 35. The transistors 34 and 35 are connected to one another in series with opposite orientations, i.e. transistors 34 and 35 are connected in anti-series, so that they do not conduct current at the same time. Two diodes 36 and 37 are connected to transistors 34 and 35 respectively. The diode 36 is connected to the transistor 34 in parallel with opposite orientations, i.e. the diode 36 and transistor 34 do not conduct current at the same time: if the transistor 34 is conducting, the diode 36 is blocked and vice versa. In other words, the transistor 34 and the diode 36 are connected in parallel but with opposing orientations. The same applies to the transistor 35 and diode 37. This arrangement enables each switching module 32 and 42 to conduct alternating current uninterrupted whenever the sign of the current changes.

The switching module 32 comprises a voltage-limiting element 39. The voltage-limiting element 39 is connected in parallel with an assembly formed by the transistors 34 and 35, and is for example a metal oxide varistor (MOV), a transil diode or a gas spark gap. The voltage-limiting element 39 has a limiting voltage Uₗᵢₘ₁, which corresponds to a voltage across its terminals when the current flowing between the source 3 and the load 5 passes through it.

Similarly, the switching module 42 comprises two transistors 44 and 45 and two diodes 46 and 47, similar at least functionally and connected in the same way as described for the transistors 34, 35 and diodes 36 and 37. The switching module 42 comprises a voltage-limiting element 49, similar at least functionally to the voltage-limiting element 39 and connected in parallel with the transistors 44 and 45. The voltage-limiting element 39 has a voltage-limiting voltage Uₗᵢₘ₂.

The limiting voltages Uₗᵢₘ₁ and Uₗᵢₘ₂ are different, for example the limiting voltage Uₗᵢₘ₁ is equal to 440V and the limiting voltage Uₗᵢₘ₂ is equal to 900V.

The switching modules 32 and 42 are configured to switch between an on-configuration and a off-configuration. In the on-configuration, the current flows in the switching module 32 through either the transistor 34 and diode 37 or through the transistor 35 and diode 36 and flows through the switching module 42 through either the transistor 44 and diode 47 or through the transistor 45 and diode 46. In particular, when the current flowing through the device 10 is alternating, the transistor 34, diode 37, transistor 44 and diode 47 initially conduct the current and then, when the current changes direction, the transistor 35, diode 36, transistor 45 and diode 46 conduct the current. More generally, in the on-configuration, at least one of the transistors 34, 35 and at least one of the transistors 44, 45 conduct the current.

In the off-configuration, the transistors 34 and 35 do not conduct current and, if current flows in the switching module 32, it flows through the voltage-limiting element 39. Likewise, when the switching module 42 is in the off-configuration, the transistors 44 and 45 do not conduct current and, if current flows in the switching module 42, it flows through the voltage-limiting element 49.

Thus, in the off-configuration, the voltages across the switching modules 32 and 42 are the limiting voltage Uₗᵢₘ₁ and the limiting voltage Uₗᵢₘ₂ respectively.

As a result of the combination effect, the limiting voltages Uₗᵢₘ₁ and Uₗᵢₘ₂ form 2^{N}−1 levels, which are distinct from each other. Here, the number Np of switching levels is equal to Np=^{2N}−1, where N is the number of switching modules. The levels are formed by the limiting voltages Uₗᵢₘ₁ and Uₗᵢₘ₂ taken alone, or summed together. The list of levels obtained is shown in the table below. For N=2 switching modules, three distinct levels P1, P2, P3 are obtained, with 3=2²−1. Here, P1 is the level with the lowest value, equal to Uₗᵢₘ₁ which is worth 440V for example, P2 is higher than P1, and has a value equal to Uₗᵢₘ₂ which is worth 900V for example, and P3 is higher than P2, with a value equal to the sum of Uₗᵢₘ₁ and Uₗᵢₘ₂, for example 1340V. Advantageously, the level P3, or generally speaking the highest level, is of the order of 1.5 times the mains voltage Uₛ.

TABLE 1

| Level | Value |
|---|---|
| P1 | Uₗᵢₘ₁ |
| P2 | Uₗᵢₘ₂ |
| P3 | Uₗᵢₘ₁ + Uₗᵢₘ₂ |

The control device 10 further comprises a current sensor 52. The current sensor 52 is configured to measure an intensity I of the current flowing between the source and the load, and in particular the current flowing through the phase conductor 7. The current sensor 52 is, for example, a Rogowski coil.

The control device 10 comprises a control unit 60, comprising a detection module 62, connected to the current sensor 52 and configured to detect an electrical fault of the short-circuit type as a function of the intensity I, measured by the current sensor 52. In the following, the term short-circuit is used to designate an electrical fault of the short-circuit type.

The control unit 60 also comprises a mechanical switch control module 64, a cell control module 66 and, advantageously, a disconnector control module 68, connected to the detection module 62 and respectively configured to control the mechanical switch 12, the interruption cell 18, and the disconnectors 23 and 24.

The control modules of the mechanical switch 64 and disconnector 68 are advantageously configured to actuate the actuators 16, 25 and 26 respectively, in order to toggle the switch 12 and the disconnectors 23 and 24 into the open configuration.

The cell control module 66 is configured to control the switching module(s) 32, 42 where the limiting voltages Uₗᵢₘ₁, Uₗᵢₘ₂ of the limiting elements 29 and 39 form a given level to enter an off-configuration. The given level is the highest level less than or equal to the dielectric strength of the mechanical switch 12 and controls the other switching modules to enter the on-configuration, as will be explained later.

The control unit 60 is an electronic circuit designed to manipulate and/or transform data represented as electronic or physical quantities in registers of the control unit 60 and/or memories into other similar data corresponding to physical data in memories, registers or other types of display devices, transmission devices or storage devices.

As specific examples, the control unit 60 is in the form of a programmable logical component, such as a FPGA (Field Programmable Gate Array), or in the form a dedicated integrated circuit, such as an ASIC (Application-Specific Integrated Circuit).

In a variant not shown, the control unit 60 comprises an information processing unit formed for example by a memory and a processor associated with the memory. The detection module 62, mechanical switch control module 64, cell control module 66, and disconnector control module 68 are each in the form of software, or a software brick, which can be executed by the processor. The memory of the control unit 60 is then able to store detection software, mechanical switch control software, cell control software, and disconnector control software. The processor is then able to run each of the processing software, mechanical switch control software, cell control software, and disconnector control software.

In a variant not shown, the detection module 62, the mechanical switch control module 64, the cell control module 66, and the disconnector control module 68 are each in the form of a programmable logical component, such as a FPGA (Field Programmable Gate Array), an integrated circuit, such as an ASIC (Application-Specific Integrated Circuit), or in the form of an analogue component.

Advantageously, the device 10 further comprises a power supply module 70, connected to the conductors 7 and 8 and to the control unit 60, in order to supply the control unit 60 with electricity. In a variant not shown, the power supply module 70 is connected to an external circuit, not connected to the conductors 7 and 8. In a variant not shown, the power supply module 70 is supplied by the transformer effect from the current flowing through the conductors 7 and 8.

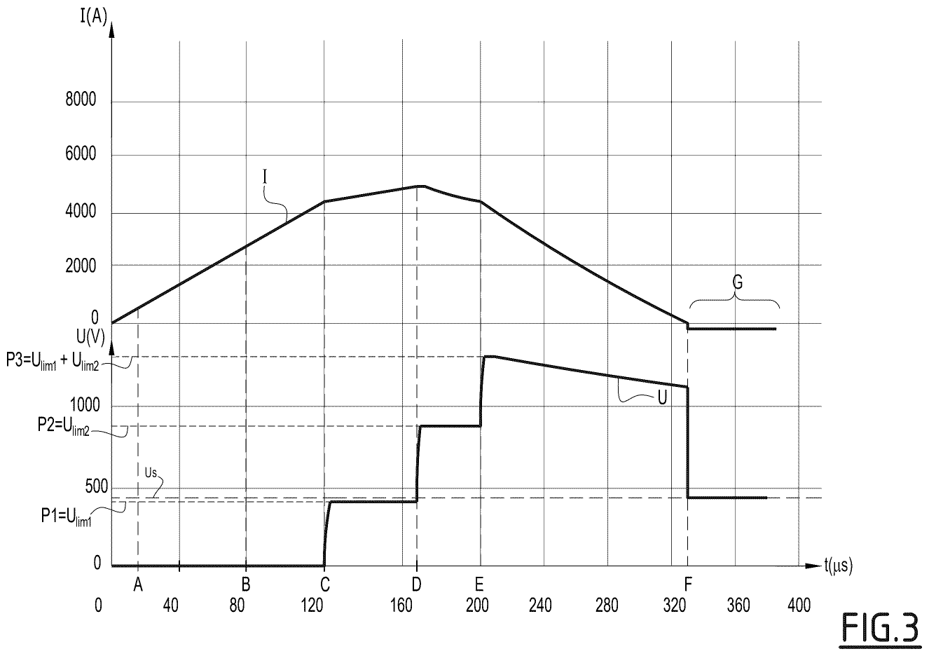

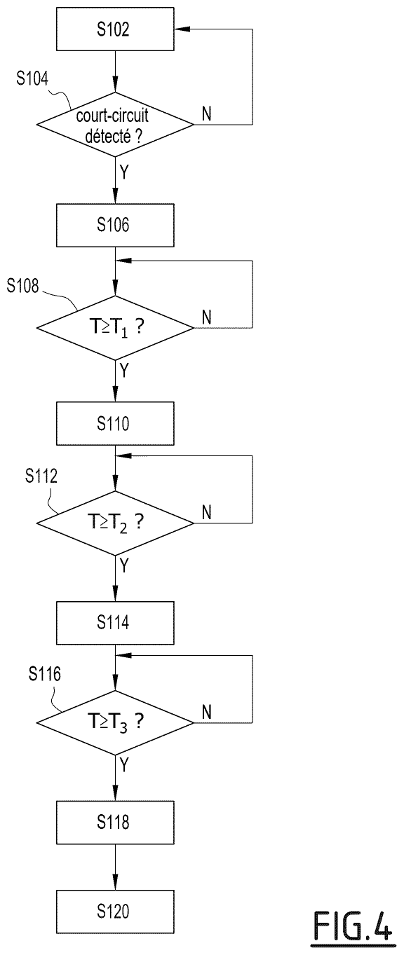

A method for operating the device 10 will now be explained, with reference to FIGS. 3 and 4.

Advantageously, the device 10 is initially in the armed configuration, i.e. the disconnectors 23 and 24 are in the closed configuration, the mechanical switch 12 is in the closed configuration, and the transistors 34, 35, 44 and 45 are conducting. Because its internal resistance is lower than that of the transistors 34, 35, 44 and 45, the mechanical switch 12 conducts all the electrical current flowing through the device 10. A voltage U across the device 10 is substantially zero.

The current sensor 52 measures the intensity I of the current flowing in the phase conductor 7 in step S102.

The control unit 60 receives the measurement of the intensity I of the current and detects, via the detection module 62, whether a short-circuit is present between the source 3 and the load 5, in step S104. If a short-circuit is not detected, then the current sensor 52 performs step S102 again and continues to measure the intensity I of the current. An iterative process is then implemented. If a short-circuit is detected, which corresponds to the moment A in FIG. 3, then the control unit 60 controls the mechanical switch 12 by toggling to the open configuration, via the mechanical switch control module 64, in step S306. The opening of the mechanical switch 12 corresponds to moment B in FIG. 3.

When a short-circuit is present between the source 3 and the load 5, or in the load 5, the intensity I increases significantly and rapidly, for example by several tens of amperes per microsecond. For example, the short-circuit is detected when the intensity I is greater than a predetermined threshold, or when a derivative of the intensity I is greater than a predetermined threshold, or when a combination of conditions on the intensity I and its derivative are met.

When the mechanical switch 12 is in the open configuration, the electrical current is transferred from the mechanical switch 12 to the interruption cell 18. However, opening the mechanical switch 12 generates an electric arc and ionisation of the medium between the contacts of the mechanical switch 12. This reduces the dielectric strength of the mechanical switch 12. Thus, before reducing or interrupting the current flowing between the source 3 and the load 5, it is necessary to wait for sufficient dielectric strength of the mechanical switch 12 to be re-established, otherwise a restrike may occur at the terminals of the mechanical switch 12, i.e. the restarting of current through the contacts of the mechanical switch 12, when the latter is in the open configuration, resulting in damage to the mechanical switch 12. The device 10 can then neither reduce nor interrupt the current.

The dielectric strength of the mechanical switch 12 increases over time until it exceeds one or more levels P1, P2, P3. In the example described here, P1 is the lowest level, so the dielectric strength of the mechanical switch 12 becomes greater than or equal to level P1 while being less than levels P2 and P3. P1 is then the greatest level less than or equal to the dielectric strength of the mechanical switch 12.

Preferably, the time required between the moment when the mechanical switch 12 switches to the open configuration and the moment when the dielectric strength of the mechanical switch 12 becomes equal to the level P1 is equal to a first waiting threshold T₁. Thus, a waiting time T is measured from the moment the mechanical switch 12 switches to the open configuration. The control unit 60 determines whether the waiting time T is greater than or equal to the first waiting threshold T₁, in step S108. If this is not the case, then the control unit 60 waits a predetermined time and then performs step S108 again. An iterative process is then implemented.

If the waiting time T is greater than or equal to the first waiting threshold T₁, the dielectric strength of the mechanical switch 12 is equal to or greater than the level P1, formed only by the limiting voltage Uₗᵢₘ₁. The cell control module 66 then controls the switching module 32 to enter the off-configuration in step S110, corresponding to moment C in FIG. 3. The transistors 36 and 37 are off and do not conduct the current, which then flows through the voltage-limiting element 39 and the switching module 42. The voltage U across the device 10, and therefore across the mechanical switch 12, is then equal to the limiting voltage Uₗᵢₘ₁. The flow of current through the voltage-limiting element 39 makes it possible to limit an increase in intensity I of the current caused by the short-circuit, according to the following formula:

$$TA ≅ 1 - \frac{U}{{U}_{s}}$$

where:
   TA is the rate of increase in intensity I;
   U is the voltage across device 10; and
   Uₛ is the nominal voltage of the current.

In practice, the voltages induced by the resistance of conductors 7 and 8 and by the fault are considered negligible, and the rate of increase TA is therefore considered to be equal to

$$1 - \frac{U}{{U}_{s}} .$$

In FIG. 3, the limiting voltage Uₗᵢₘ₁ is lower than the rated current voltage Uₛ, for example of the order of 440V, for a rated current voltage Uₛ on the order of 450V. Thus, when the switching module 32 is controlled to enter the off-configuration, the voltage U across the device 10 is on the order of 440 V and the intensity I increases more slowly than when the switching module 32 was in the on-configuration.

The dielectric strength of the mechanical switch 12 continues to increase and becomes equal to and then greater than the P2 level. Thus, the P2 level is the highest level less than or equal to the dielectric strength of the mechanical switch 12. Preferably, the time between the moment when the mechanical switch 12 switches to the open configuration and the moment when the dielectric strength of the mechanical switch 12 becomes equal to the level P2 is equal to a second waiting threshold T₂.

The control unit 60 determines whether the waiting time T is greater than or equal to the second waiting threshold T₂, in step S108. If the waiting time T is less than the second waiting threshold T₂, then the control unit 60 waits for a predetermined time and then performs step S112 again. An iterative process is then implemented.

If the waiting time T is greater than or equal to the second waiting threshold T₂, then the cell control module 66 controls the switching module 42 to enter the off-configuration and the switching module 32 to enter the on-configuration in step S114, which corresponds to moment D in FIG. 3. The transistors 46 and 47 are off and do not conduct the current, which then flows through the voltage-limiting element 49 and the switching module 32. The voltage U across the device 10, and therefore across the mechanical switch 12, is then equal to the limiting voltage Uₗᵢₘ₂.

In FIG. 3, the limiting voltage Uₗᵢₘ₁ is higher than the rated current voltage Uₛ, for example of the order of 900V, for a rated current voltage Uₛ on the order of 450V. Thus, when the switching module 32 is controlled to enter the off-configuration, the voltage U across the device 10 is on the order of 900V and the intensity I decreases.

The dielectric strength of the mechanical switch 12 continues to increase and becomes equal to and then greater than the P3 level, which then becomes the highest level less than or equal to the dielectric strength of the mechanical switch 12.

Preferably, the time between the moment when the mechanical switch 12 switches to the open configuration and the moment when the dielectric strength of the mechanical switch 12 becomes equal to the level P3 is determined in advance, and is equal to a second waiting threshold T₃.

The control unit 60 determines whether the waiting time T is greater than or equal to the second waiting threshold T₃, in step S116. If the waiting time T is less than the third waiting threshold T₃, then the control unit 60 waits for a predetermined time and then performs step S116 again. An iterative process is then implemented.

If the waiting time T is greater than or equal to the third waiting threshold T₃, then the cell control module 66 controls the switching modules 32 and 42 to enter the off-configuration in step S118, which corresponds to moment E in FIG. 3, the level P3 being formed by the limit voltages Uₗᵢₘ₁ and Uₗᵢₘ₂ summed together.

In step S118, the transistors 34, 35, 44 and 45 are turned off. The current then flows through the voltage-limiting element 39 and the limiting element 49. The voltage U across the device 10 is therefore equal to the sum of the limiting voltages Uₗᵢₘ₁ and Uₗᵢₘ₂.

As the voltage at the terminals of the device 10 is higher than the mains voltage and higher than the limiting voltage Uₗᵢₘ₂, which was previously applied to the terminals of device 10, the intensity I of the current flowing in the device 10 decreases more rapidly than when the limiting voltage Uₗᵢₘ₂ was applied to the terminals of device 10, until it reaches zero, as can be seen in zone G in FIG. 3. When the intensity I becomes zero, the current is interrupted between the source 3 and the load 5, and the voltage at the terminals of the device 10 becomes equal to the nominal voltage of the current Uₛ, as can be seen from moment F. Advantageously, a tripping time Td between the moment when the short-circuit is detected and the moment when all the switching modules have switched to the off-configuration, i.e. a time between moments A and F, is less than 1 ms, preferably less than 800 μs, even more preferably less than 400 μs.

Advantageously, when the intensity I has become zero, the disconnector control module 68 activates the actuators 25 and 26 in order to toggle the disconnectors 23 and 24 to the open configuration, in step S120. For example, if the actuators 25 and 26 are coils, the disconnector control module 68 sends an electrical pulse to the actuators 25 and 26. This generates a magnetic field which interacts with the disconnectors 23 and 24 and enables them to switch to the open configuration. The device 10 is then in the triggered configuration.

The disconnectors 23 and 24 only switch to the open configuration once the current has been interrupted and serve to galvanically isolate the source 3 and the load 5, but do not take part in interrupting the current as such.

Advantageously, the standby thresholds T₁, T₂ and T₃ are determined in advance, for example by the manufacturer of the device 10, as a function of the characteristics of the mechanical switch 12 and the values of the thresholds P1, P2 and P3, formed by the limiting voltages Uₗᵢₘ₁ and Uₗᵢₘ₂. Alternatively, the waiting thresholds T₁, T₂ and T₃ are determined by the control unit 60, for example as a function of the intensity I at the moment when the mechanical switch 12 switches to the open configuration, and the values of the thresholds P1, P2 and P3. More generally, if the device 10 comprises more than two modules, the standby thresholds are determined as a function of the characteristics of the mechanical switch 12 and the values of the thresholds formed by the limiting voltages of the voltage-limiting elements of the switching modules.

Controlling the switching modules 32 and 42 thus enables the current to be limited earlier, in this case as soon as the first waiting threshold T₁ is reached, and to be limited or even reduced as quickly as possible, by applying to the terminals of the device 10 a voltage as close as possible to the dielectric strength of the mechanical switch. This makes it possible in particular to limit the increase in intensity I, to avoid overheating of conductors 7 and 8, and also to choose transistors 34, 35, 44 and 45 whose current withstand is lower than for an equivalent device without switching modules controlled successively in the off-configuration while guaranteeing a leakage current of the voltage-limiting elements 39 and 49 compatible with the energy withstand of the components of the device 10.

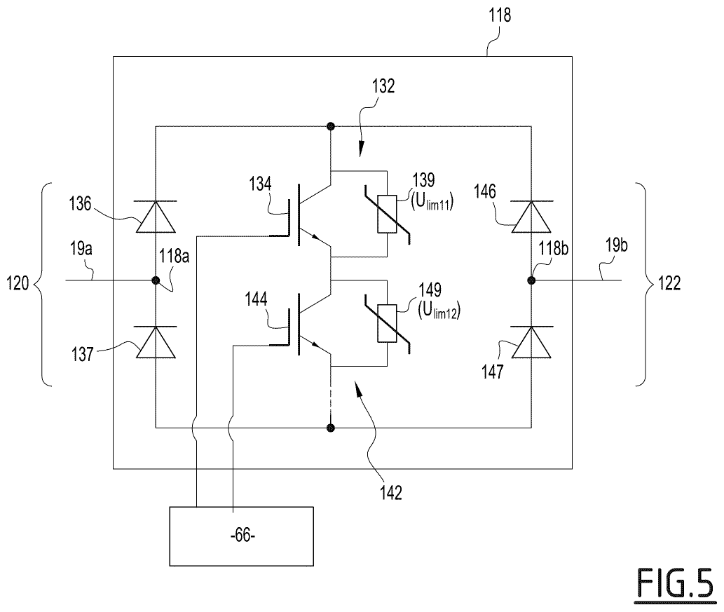

FIG. 5 is a diagram of an interruption cell 10 of an electrical protection device 10 in accordance with a second embodiment of the invention, as an alternative to the interruption cell 18. The interruption cell 118 is, in a similar way to the interruption cell 18, connected in parallel with the mechanical switch 12, such that the input 12a and the output 12b of the mechanical switch 12 are connected respectively to an input 118a and an output 118b of the interruption cell 118. More specifically, the input 12a of the mechanical switch 12 and the input 118a of the interruption cell 118 are connected by the electrical link 19a, which is non-interruptible, and the output 12b of the mechanical switch 12 is connected to the output 18b of the interruption cell 118 by the electrical link 19b, which is also non-interruptible. The interruption cell 118 comprises two rectifying branches 120 and 122. Each rectifying branch 120 and 122 comprises two diodes, 136 and 137 respectively for the rectifying branch 120, and 146 and 147 for the rectifying branch 122. The diodes 136 and 137 are connected to each other in series with opposite orientations, i.e. the diodes 136 and 137 are connected in series and never conduct current at the same time. The same applies to the diodes 146 and 147.

The input 118a and output 118b of the interruption cell 118 correspond respectively to the midpoint of the rectifying branch 120, between the diodes 136 and 137, and to the midpoint of the rectifying branch 122, between the diodes 146 and 147. In this way, the interruption cell 118 is connected in parallel with the mechanical switch 12 via the midpoint of each rectifying branch 120 and 122.

The interruption cell 118 comprises two interruption modules 132 and 142, but, in a variant not shown, comprises more than two interruption modules. The interruption modules 132 and 142 are connected in parallel with the rectifying branches 120 and 122 and in series with each other. Alternatively, the interruption cell 118 comprises more than two interruption modules, connected in series with the interruption module 142 and in parallel with the branches 120 and 122, as symbolised by the dotted line in FIG. 5.

The interruption modules 132 and 142 respectively comprise a switchable semiconductor element, in this case a transistor 134 and 144 and a voltage-limiting element 139 and 149. The voltage-limiting element 139 is connected in parallel with the transistor 134 and the voltage-limiting element 149 is connected in parallel with the transistor 144. In the example shown in FIG. 5, the transistors 134 and 144 are unidirectional current transistors, the direction of which is indicated by an arrow on each transistor. The voltage-limiting elements 139 and 149 are similar, at least functionally, to the voltage-limiting elements 39 and 49 and have a limiting voltage Uₗᵢₘ₁₁ and Uₗᵢₘ₁₂ respectively. The limiting voltage Uₗᵢₘ₁₁ is advantageously different from the limiting voltage U_{Ulim12}, but in one variant, these voltages are identical.

The interruption cell 118 is configured to be independent of the direction of current flow by means of diodes 136, 137, 146 and 147, so that the switching modules 132 and 142, which are unidirectional, can be used bidirectionally. The arrangement of diodes 136, 137, 146 and 147 limits the number of diodes in the interruption cell 118 to four. Thus, even when the interruption cell 118 comprises more than two switching modules, only the four diodes 136, 137, 146 and 147 are required for their operation, thus limiting the number of diodes required relative to the interruption cell 18.

The method for controlling the protection device 10 comprising an interruption cell 118 is similar to that described previously for the protection device comprising the interruption cell 18, and is not again described in detail.

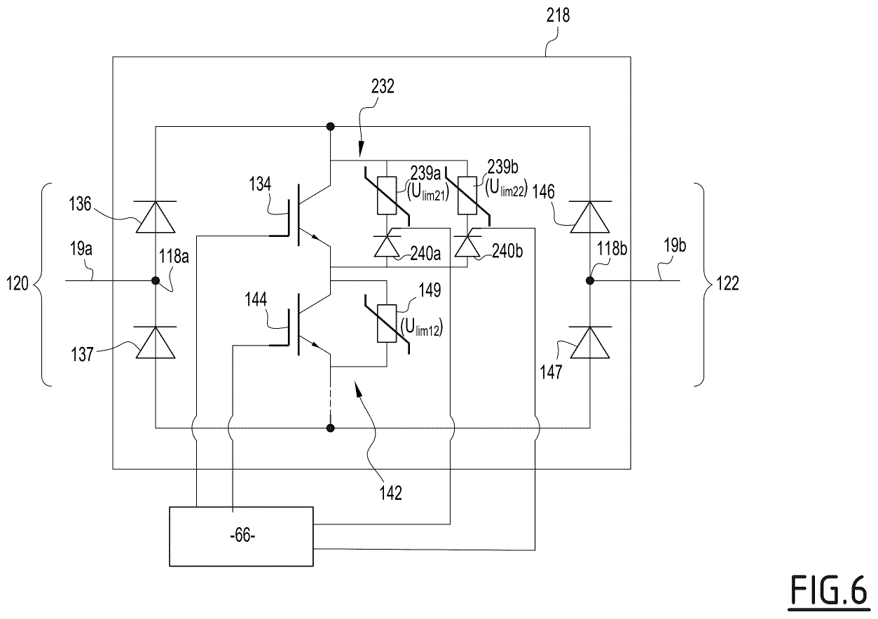

FIG. 6 is an electrical schematic of an interruption cell 218 of an electrical protection device 10 in accordance with a third embodiment of the invention, as an alternative embodiment to the interruption cells 18 and 118.

The elements of the interruption cell 218 which are similar to those of the interruption cell 118 are designated by the same reference number and are not described again in detail.

The interruption cell 218 comprises a switching module 232, which replaces the switching module 132 and differs from the latter in that it comprises a plurality of limiting elements, in this case two limiting elements 239a and 239b. The switching module 232 is referred to as a variable-voltage switching module. The limiting elements 239a and 239b respectively have a limiting voltage Uₗᵢₘ₂₁ and Uₗᵢₘ₂₂ which are distinct from each other and different from the limiting voltage Uₗᵢₘ₁₂. Each limiting element 239a and 239b is respectively associated with a switching device 240a and 240b, with which it is connected in series. In the example shown in FIG. 6, the switching members 240a and 240b are thyristors. Alternatively, the switching members 240a and 240b are semiconductors whose switching can be controlled. The limiting element 239a and its associated switching member 240a are connected in parallel with the transistor 134. The same applies to the limiting element 239b and its associated switching member 239b.

In a variant not shown, other limiting elements, each associated with a switching device to which they are connected in series, are connected in parallel with the transistor 134.

In this embodiment, the number N of switching modules is equal to 2.

The limiting voltages Uₗᵢₘ₁₂, Uₗᵢₘ₂₁, and Uₗᵢₘ₂₂ form separate levels from one another. The number of levels formed is equal to:

$$Np = ( x + 1 ) ( y + 1 ) - 1$$

Where Np is the number of switching levels;
x is the number of parallel limiting elements of the transistor 134; and
y is the number of parallel limiting elements of the transistor 144.

In the example in FIGS. 6, x=2 and y=1, giving a total of five levels P′1 to P′5 listed in the table below.

TABLE 2

| Level | Value |
|---|---|
| P′1 | Uₗᵢₘ₂₁ |
| P′2 | Uₗᵢₘ₁₂ |
| P′3 | Uₗᵢₘ₂₂ |
| P′4 | Uₗᵢₘ₂₁ + Uₗᵢₘ₁₂ |
| P′5 | Uₗᵢₘ₂₂ + Uₗᵢₘ₁₂ |

In table 2, the levels P′1 to P′5 are listed in ascending order, with P′1 being the lowest level and P′5 the highest level.

In the embodiment shown in FIG. 6, the number Np of switching levels is 5, which is strictly greater than the value 2^{N}−1, where N is equal to 2, i.e. 3.

The levels are formed by at most one limiting voltage of a limiting element belonging to the variable-voltage switching module 232. In other words, the same level cannot be formed with the two limiting voltages Uₗᵢₘ₂₁ and Uₗᵢₘ₂₂. In the case where the device 10 comprises the interruption cell 218, the cell control module 66 is further configured to control the switching members 240a and 240b to enter an on-state and an-off state, in addition to being configured to control the switching module or modules whose limiting voltages of the limiting elements form a given level to enter the on-configuration or off-configuration, the given level being the highest level less than or equal to the dielectric strength of the mechanical switch 12, and to control the other switching modules to enter the on-configuration.

When the switching members 240a or 240b are in the on-state, they allow the current to flow, and when they are in the off-state, the current cannot flow through the switching members 240a and 240b.

The method for controlling the protection device 10 comprising an interruption cell 218 is similar to that described previously for the protection device comprising the interruption cell 18, apart from the differences listed below. In the example shown in FIG. 6, the control method will be carried out for five levels P′1 to P′5, rather than three. In addition, when the control module 66 controls the switching module(s) whose limiting voltages of the limiting elements form a given level to enter the off-state, the given level being the highest level less than or equal to the dielectric strength of the mechanical switch 12, and this given level is formed by one of the limiting voltages of a switching member belonging to the variable-voltage switching module 232, the cell control module 66 also controls the associated switching member to enter the on-state, and the other switching members of the variable-voltage switching module 232 to enter the off-state.

For example, if level P′4 is the highest level less than or equal to the dielectric strength of mechanical switch 12, the cell control module 66 controls modules 232 and 142 to enter the off-configuration by turning off the transistors 134 and 144, controls the switching member 240a to enter the on-state and the switching member 240b to enter the off-state. The current therefore flows through the voltage-limiting elements 239a and 149. In practice, level P′4 can only be reached after a transient passage through level P′2, in order to take into account the time required for the current flowing through the thyristors to be cancelled, which enables the transistor 240a to be turned on and the thyristor 240b to be turned off.

Alternatively, not shown, the interruption cell 218 comprises more than two variable-voltage switching modules.

For example, if the interruption cell 118 or 218 comprises three variable-voltage switching modules, the number Np of switching levels is greater than or equal to 2³−1, i.e. 7. According to another example where the interruption cell 118 or 218 comprises three variable-voltage switching modules, the number Np of switching levels is greater than or equal to 2⁴−1, i.e. 15. The other possible minimum values for the number Np of switching levels can be calculated from the above.

Alternatively, not shown, the source 3 and the load 5 are connected together by a plurality of phase conductors, for example three. In this case, the device 10 advantageously comprises, for each phase conductor, a mechanical switch and an interruption cell connected in parallel with the mechanical switch.

Optionally, a mechanical switch is connected to the neutral conductor, with an interruption cell connected in parallel with the mechanical switch.

In one variant not shown, the electrical installation 1 does not comprise a neutral conductor 8.

Any feature described for one embodiment or variant in the foregoing may be implemented for the other embodiments and variants described above, insofar as technically feasible.

1. An electrical protection device, configured to be connected between a source and a load, the device comprising:
a mechanical switch, configured to switch between a closed configuration, wherein the mechanical switch conducts a current flowing between the source and the load, and an open configuration, wherein the mechanical switch does not conduct the current;
an interruption cell, connected in parallel with the mechanical switch, the interruption cell comprising N switching modules connected in series with each other, N being greater than or equal to two, each switching module comprising:
at least one semiconductor element;
a voltage-limiting element connected in parallel with the semiconductor element(s),
each voltage-limiting element having a limiting voltage, different from the limiting voltage of the other voltage-limiting elements, each switching module being configured to switch between an on-configuration, wherein the current flows through the or one of the semiconductor elements of the switching module, and an off-configuration, wherein if the current flows through the switching module, it flows through the voltage-limiting element;
a current sensor, configured to measure a current intensity;
a control unit comprising:
a detection module configured to detect an electrical fault of the short-circuit type as a function of the intensity measured by the current sensor;
a mechanical switch control module, configured to control the mechanical switch to enter the open configuration when an electrical fault is detected,
a cell control module, configured to control each switching module to enter the off-configuration,
wherein an input of the mechanical switch and an input of the interruption cell are connected to each other by a non-interruptible electrical link and an output of the mechanical switch and an output of the interruption cell are connected to each other by a non-interruptible electrical link,
wherein the limiting voltages, alone and/or summed together, form at least 2^{N}−1 distinct levels,
and wherein the cell control module is configured to:
control the switching module(s) whose limiting voltages of the voltage-limiting elements form a given level into the off-configuration, the given level being the highest level less than or equal to a dielectric strength of the mechanical switch, and
control the other switching modules to enter the on-configuration.

2. The device according to claim 1, wherein each switching module comprises two semiconductor elements which are unidirectional in current and connected to each other in series with opposite orientations, and for each semiconductor element a diode is connected in parallel with opposite orientations to the semiconductor element.

3. The device according to claim 1, wherein:
the interruption cell comprises two rectifying branches, the input and the output of the interruption cell respectively forming a midpoint of one of the rectifying branches, each rectifying branch comprising two diodes arranged on either side of the midpoint, connected in series to each other with opposite orientations;
the switching modules are connected in parallel to the rectifying branches; and
each switching module comprises a single semiconductor element connected in parallel to the voltage-limiting element.

4. The device according to claim 3, comprising at least three switching modules.

5. A device according to claim 1, wherein:
one of the switching modules, referred to as a variable-voltage switching module, comprises a plurality of voltage-limiting elements each having a limiting voltage different from each other and different from the limiting voltages of the voltage-limiting elements of the other switching modules;
each voltage-limiting element of the variable-voltage switching module is associated with a switching member with which it is connected in series, each voltage-limiting element and its associated switching member being connected in parallel with the semiconductor element(s);
the levels are formed by at most one limiting voltage of a voltage-limiting element of the variable-voltage switching module, possibly summed with one or more limiting voltages of the other switching modules; and
the cell control module is further configured to, when a given limiting voltage element of the variable-voltage switching module forms part of a given level, the given level being the highest level less than or equal to the dielectric strength of the mechanical switch, toggle the switching member associated with the given limiting voltage element from an on-state to an off-state, and to control the other switching members of the variable-voltage switching module to enter the off-state.

6. The device according to claim 1, further comprising a disconnector, connected in series with the mechanical switch without being connected in parallel with the interruption cell.

7. The device according to claim 1, wherein a tripping time between the detection of the electrical fault of the short-circuit type by the detection module and all the switching modules toggling into the off-configuration is less than 1 ms.

8. The device according to claim 1, wherein a tripping time between the detection of the electrical fault of the short-circuit type by the detection module and all the switching modules toggling into the off-configuration is less than 800 μs.

9. The device according to claim 1, wherein a tripping time between the detection of the electrical fault of the short-circuit type by the detection module and all the switching modules toggling into the off-configuration is less than 400 μs.

10. An electrical installation comprising a source, a load connected to the source, and an electrical protection device according to claim 1, connected between the source and the load, a nominal voltage of the current flowing between the source and the load being less than 1500 V.

11. A method for controlling an electrical protection device, the device being according to claim 1, the method comprising at least the following steps:
measuring the intensity of the current, by the current sensor;
detecting an electrical fault of the short-circuit type, by the detection module, as a function of the intensity measured by the current sensor;
when an electrical fault of the short-circuit type is detected, controlling the mechanical switch to enter the open configuration by means of the mechanical switch control module; and
when the dielectric strength of the mechanical switch is greater than or equal to a given level, the given level being the highest level less than or equal to the dielectric strength of the mechanical switch, controlling the switching module(s) whose limiting voltages of the limiting elements form the given level, and of the other switching modules, to enter the on-configuration.

12. The control method as claimed in claim 11, wherein:
one of the switching modules, referred to as a variable-voltage switching module, comprises a plurality of voltage-limiting elements each having a limiting voltage different from each other and different from the limiting voltages of the voltage-limiting elements of the other switching modules;
each voltage-limiting element of the variable-voltage switching module is associated with a switching member with which it is connected in series, each voltage-limiting element and its associated switching member being connected in parallel with the semiconductor element(s);
the levels are formed by at most one limiting voltage of a voltage-limiting element of the variable-voltage switching module, possibly summed with one or more limiting voltages of the other switching modules; and
the cell control module is further configured to, when a given limiting voltage element of the variable-voltage switching module forms part of a given level, the given level being the highest level less than or equal to the dielectric strength of the mechanical switch, toggle the switching member associated with the given limiting voltage element from an on-state to an off-state, and to control the other switching members of the variable-voltage switching module to enter the off-state,
the method further comprising, when a given limiting voltage element of the variable-voltage switching module forms part of a given level and the dielectric strength of the mechanical switch is greater than or equal to the given level, a step of controlling the switching component associated with the limiting voltage element to enter the on-state, and the other switching components of the variable-voltage switching module to enter the off-state, is performed.
